(19) United States
(12) Patent Application Publication
(10) Pub. No.: US 2007/0124495 A1
(43) Pub. Date: May 31, 2007

(54) Methods and systems for policy based routing

(75) Inventor: Sreedharan Sreejith, Santa Clara, CA (US)

Correspondence Address: CONLEY ROSE, P.C., 5700 GRANITE PARKWAY, SUITE 330, PLANO, TX, 75024, US

(73) Assignee: Samsung Electronics Co., Ltd.

(21) Appl. No.: 11/288,845

(22) Filed: Nov. 29, 2005

(51) Int. Cl. G06F 15/173

(52) U.S. Cl. 709/238

(57) ABSTRACT

A system is provided that includes a hardware forwarding engine that performs policy based routing. The system also comprises a processor coupled to the hardware forwarding engine, the processor having a software forwarding engine that performs policy based routing. If a data packet is forwarded from the hardware forwarding engine to the software forwarding engine, the hardware forwarding engine modifies a header of the data packet to include policy information.

### CROSS-REFERENCE TO RELATED APPLICATIONS

This application is related to U.S. patent application Ser. No. ______, entitled “Methods and Systems for Routing Packets with a Hardware Forwarding Engine and a Software Forwarding Engine”, by Sreedharan Sreejith, et al., filed on even date herewith, which is incorporated herein by reference.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure is directed to communication networks, and more particularly, but not by way of limitation, to routers that implement a hybrid (hardware and software) forwarding architecture.

### BACKGROUND OF THE INVENTION

Modern communication networks are tasked with transferring large amounts of data between different computers such as servers and clients. To transfer the data, communication parameters are established such as the format of the data to be transferred, the speed and bandwidth with which the data is sent, the source of the data, and the destination of the data. By the time the data has been transferred from its source location to its destination, the data may have passed through several routers and may have changed its format several times. The speed with which routers are able to process and forward the data affects the overall data transfer rate of a communication network. Typically, a higher data transfer rate is preferred by industry and consumers.

### SUMMARY OF THE INVENTION

In at least some embodiments, a system comprises a hardware forwarding engine that performs policy based routing. The system also comprises a processor coupled to the hardware forwarding engine, the processor having a software forwarding engine that performs policy based routing. If a data packet is forwarded from the hardware forwarding engine to the software forwarding engine, the hardware forwarding engine modifies a header of the data packet to include policy information.

In at least some embodiments, a method comprises determining a policy associated with a data packet, the determining being performed by a hardware forwarding engine. If a next hop of the data packet is a processor interface, the method also comprises modifying a header of the data packet to include policy information that can be used by a processor associated with the processor interface to identify the policy.

In at least some embodiments, a routing system comprises a hardware forwarding engine that classifies data packets received from a network interface. The routing system also comprises a processor coupled to the hardware forwarding engine, the processor having a software forwarding engine that classifies data packets received from a processor interface. If a data packet received from the network interface is destined for the processor interface, the hardware forwarding engine classifies the data packet, inserts classification results into a header of the data packet, and forwards the data packet to the processor. The software forwarding engine is configured to extract the classification results from the header of the data packet received from the hardware forwarding engine and to route the data packet based on the classification results. These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 illustrates a routing architecture in accordance with embodiments of the invention;

FIG. 2 illustrates a block diagram of the routing architecture of FIG. 1 in accordance with embodiments of the invention;

FIG. 3 illustrates packet traversal through various functional layers of a routing architecture in accordance with embodiments of the invention;

FIG. 4 illustrates flowcharts for a hardware forwarding engine and a software forwarding engine in accordance with embodiments of the invention;

FIGS. 5A-5B illustrate a block diagram of packets traversing a hardware forwarding engine plane and a software forwarding engine plane in accordance with embodiments of the invention; and

FIG. 6 illustrates a policy encoding scheme in accordance with embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical, wireless, or other electrical connection. Thus, if a first device couples to a second device, that connection may be through a direct electrical connection, through an indirect electrical connection via other devices and connections, through an optical electrical connection, or through a wireless or other electrical connection, for example.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

Embodiments of the invention forward data packets in a communication network. In some embodiments, routers implement policy based routing (PBR) to forward data packets. PBR provides a flexible means of routing packets that enables users to configure a defined policy for traffic flows, lessening reliance on routes derived from routing protocols. In some embodiments, PBR extends and complements the existing routing mechanisms provided by routing protocols.

PBR enables tasks such as: 1) classifying traffic based on extended access list criteria; 2) setting internet protocol (IP) precedence bits that enable differentiated classes of service; or 3) routing packets to specific traffic-engineered paths. For example, PBR may specify that priority traffic be routed via a high-cost link. The routing policies can allow or deny paths based on one or more parameters such as the identity of a particular end system (e.g., an internet protocol (IP) address or port number), an application protocol, or the size of data packets.

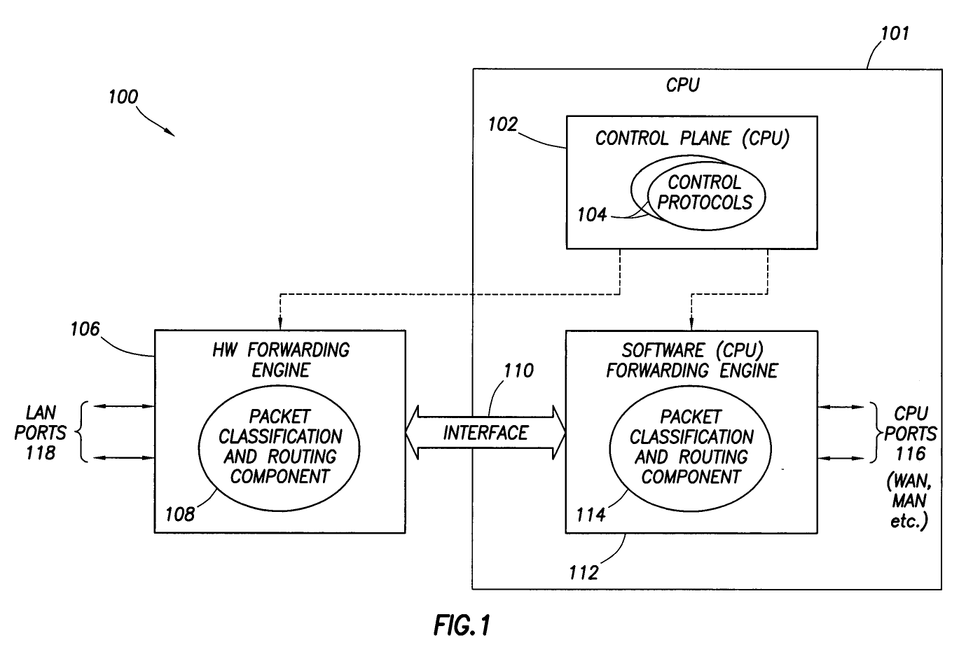

FIG. 1 illustrates a routing architecture 100 in accordance with embodiments of this disclosure. As shown in FIG. 1, the routing architecture 100 comprises a hardware (HW) forwarding engine (FE) 106 coupled to a central processing unit (CPU) 101. The CPU 101 comprises a software (SW) forwarding engine (FE) 112 as well as a control plane 102 having one or more control protocols 104. The control protocols 104 establish how the HW FE 106 and the SW FE 112 handle data packets received from ports such as Local Area Network (LAN) ports 118 or CPU ports 116 (e.g., Wide Area Network (WAN) ports or Metropolitan Area Network (MAN) ports). As shown, in some embodiments, the HW FE 106 interfaces with the LAN ports 118 and the SW FE 112 interfaces with the CPU ports 116.

The HW FE 106 and the SW FE 112 are coupled via an interface 110 such as an Ethernet interface or some other communication interface. As shown, the HW FE 106 comprises a packet classification and routing component 108. For example, the component 108 may classify packets by searching a policy database containing packet matching policies or rules. In some embodiments, the policy database is based on Ternary Content Addressable Memory (TCAM). If a packet does not match any policies in the database, other routing techniques such as longest prefix match (LPM) routing are implemented to route the packet. If a packet matches a policy in the database, the packet is classified and routed based on the policy. Once a packet is classified, the component 108 may perform a variety of actions such as remark the quality of service (QoS) attributes, consult route entries and route the packet to the next “hop”.

Similar to the HW FE 106, the SW FE 112 comprises a packet classification and routing component 114. The component 114 classifies and route packets based on software executed by the CPU 101. Again, the packets may be classified based on a database containing packet matching policies or rules. If a packet does not match any policies in the database, other routing techniques are implemented to route the packet. If a packet matches a policy in the database, the packet is classified and routed based on the policy. Once a packet is classified, the component 114 may perform a variety of actions such as remark the quality of service (QoS) attributes, consult route entries and route the packet to the next “hop”.

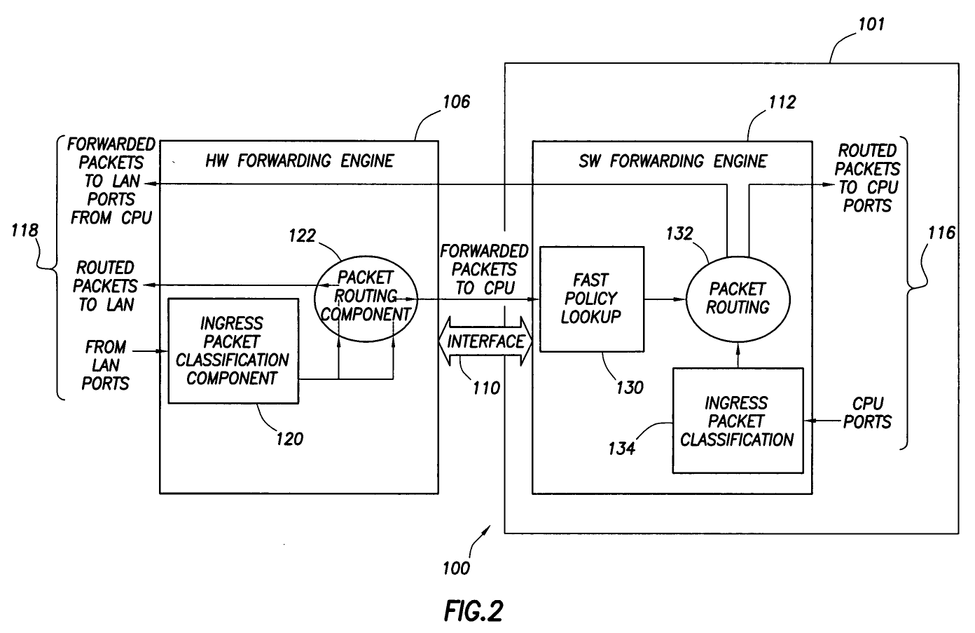

FIG. 2 illustrates a block diagram of the routing architecture 100 of FIG. 1 in accordance with embodiments of the disclosure. In FIG. 2, the traversal of data packets through the HW FE 106 and the SW FE 112 of the CPU 101 is shown. As shown, data packets from the LAN ports 118 are received by an ingress packet classification component 120 of the HW FE 106. In some embodiments, the ingress packet classification component 120 searches a policy database using, for example, TCAM-based classification. If a packet matches a policy in the database, the packet is classified based on the policy. If a packet does not match any policies in the database, the packet remains unclassified. In either case, the packet is forwarded to a packet routing component 122 that routes the packet using policy based routing or, if the packet is unclassified, another routing technique such as LPM. If the next hop indicated by a packet's route entry resides in a network interface attached to the HW FE 106, the packet routing component 122 forwards the packet back to the LAN ports 118. If the next hop indicated by a packet's route entry resides in a processor interface (e.g., of the CPU 101), the packet routing component 122 forwards the packet to the CPU 101 via the interface 110 (e.g., an Ethernet interface).

To improve the speed with which the SW FE 112 processes packets forwarded to the CPU 101, the packet routing component 122 of the HW FE 106 conveys the packet classification results determined by the HW SE 106 to the SW FE 112. For example, the classification results may be conveyed to the SW FE 112 by inserting the information in an unused packet header field (e.g., an unused “layer2” header field) transmitted with packets forwarded to the SW FE 112. By extracting the classification results from the header, the SW FE 112 is able to provide policy based routing without performing the entire classification process (e.g., searching through a plurality of policies in a database). Because the classification process can be time-consuming, especially if the number of policy rules is high, forwarding the classification results to the SW FE 112 (such that the SW FE 112 does not need to perform the entire classification process) increases routing efficiency. In at least some embodiments, the increased efficiency of the router architecture 100 may be independent of proprietary mechanisms that rely on packet format and meta data. Additionally or alternatively, the router architecture 100 may be implemented with off-the-shelf component from various vendors.

In FIG. 2, packets forwarded to the CPU 101 via the interface 110 are received by a fast policy lookup component 130. The fast policy lookup component 130 either retrieves the classification results provided from the HW FE 106 or recognizes that an incoming packet is unclassified. In some embodiments, the classification results include a policy index value (e.g., a number) or other identifier that enables the fast policy lookup component 130 to retrieve policies from a database or table and classify packets without having to perform a search (i.e., the lookup component 130 can directly access the policies from a database using the policy index value). After the lookup process is complete or after packets are determined to be unclassified, the fast policy lookup component 130 forwards the packets to a packet routing component 132 which inspects each packet's route entry to determine the next “hop”. If the next hop indicated by a packet's route entry resides in a network interface attached to the HW FE 106, the packet routing component 132 forwards the packet through the HW FE 106 to the LAN ports 118. If the next hop indicated by a packet's route entry resides in a CPU interface, the packet routing component 122 forwards the packet to the CPU ports 116.

In FIG. 2, the routing architecture 200 also shows the traversal of data packets that are received from the CPU ports 116. For example, in some embodiments, data packets from the CPU ports 116 are received by an ingress packet classification component 134 of the SW FE 112. The ingress packet classification component 134 searches a policy database using, for example, TCAM-based classification. If a packet matches a policy in the database, the packet is classified based on the policy. If a packet does not match any policies in the database, the packet remains unclassified. In either case, the packet is forwarded to a packet routing component 132 that routes the packet using policy based routing or, if the packet is unclassified, another routing technique such as LPM. If the next hop indicated by a packet's route entry resides in a network interface attached to the HW FE 106, the packet routing component 132 forwards the packet through the HW FE 106 to the LAN ports 118. If the next hop indicated by a packet's route entry resides in a CPU interface, the packet routing component 132 forwards the packet to the CPU ports 116.

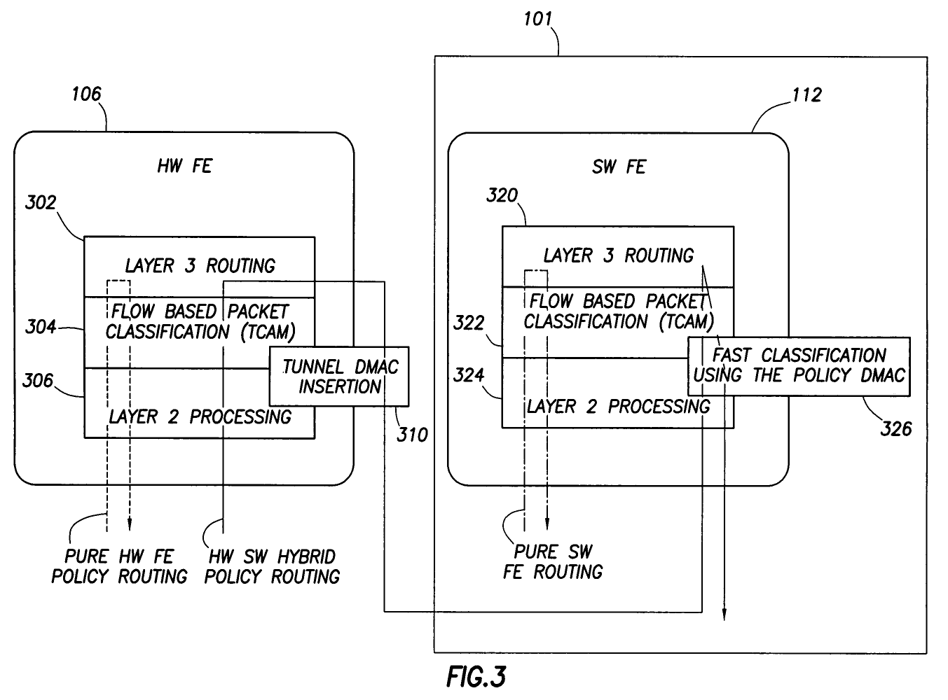

FIG. 3 illustrates packet traversal through various functional layers of a routing architecture 300 in accordance with embodiments of the disclosure. As shown in FIG. 3, the HW FE 106 and the SW FE 112 are each shown with various functional layers. For example, in some embodiments, the HW FE 106 comprises a “layer2” processing layer 306, a flow based packet classification layer 304 (e.g., TCAM-based classification), and a “layer3” routing layer 302. The HW FE 106 also has a tunnel Destination Media Access Control (DMAC) insertion layer 310.

The SW FE 112 provides functions similar to the HW FE 106 and comprises a layer2 processing layer 324, a flow based packet classification layer 322, and a layer3 routing layer 320. The SW FE 112 also comprises a fast classification layer 326. In some embodiments, the fast classification layer 326 extracts classification information from packet headers that have been modified by the tunnel DMAC insertion layer 310 of the HW FE 106.

In FIG. 3, a “pure” HW FE policy routing operation (i.e., an operation that involves the HW FE 106, but not the SW FE 112), a “pure” SW FE policy routing operation (i.e., an operation that involves the SW FE 112, but not the HW FE 106), and a HW SW hybrid policy routing operation (i.e., an operation that involves both the HW FE 106 and the SW FE 112) are shown. In a pure HW FE policy routing operation, data packets are received by the layer2 processing layer 306. After layer2 processing (e.g., extracting next hop information), the flow based packet classification layer 304 classifies each received packet or determines which packets cannot be classified. For example, packets may be classified by searching a policy database for a policy that matches each given packet. If a packet does not match with any policies of the database, the packet remains unclassified. The layer3 routing layer 302 then routes packets to the next hop based on the policy associated with each packet or, for packets that are unclassified, based on another routing technique (e.g., LPM routing). In the routing process, data packets may be forwarded to the layer2 processing layer 306, which adds a layer2 header to each packet (i.e., a layer3 packet is encapsulated in a layer2 header) and forwards the packets to an interface attached to the HW FE 106 (e.g., the LAN ports 118).

If the next hop resides in a WAN port (e.g., a WAN port of the CPU 101), the HW SW hybrid policy routing operation is performed. In the hybrid policy routing operation, the HW FE 106 modifies the layer2 header (e.g., an Ethernet header) that encapsulates the layer3 packet. For example, in some embodiments a DMAC data field of the layer2 header is modified by the tunnel DMAC insertion layer 310 to include classification results (e.g., signature, policy index information or failure information) determined by the classification layer 304. The HW FE 106 then forwards the encapsulated packet to the SW FE 112.

At the SW FE 112, the layer2 processing layer 324 receives the encapsulated layer3 packet and may extract the classification results from the DMAC data field. The fast classification layer 326 uses the policy index information to directly look up policies from a policy route database or table without performing searching (e.g., TCAM-based searching) or Time-To-Live (TTL) decrements. After the lookup process classifies the packet or, if the packet is unclassified, the layer3 packet is routed by the layer3 routing layer 320 to the next hop. In the routing process, data packets may be forwarded to the layer2 processing layer 324, which adds a layer2 header to the packet and forwards the packets to the appropriate interface (e.g., either the LAN ports 118 or the CPU ports 116).

In a pure SW FE policy routing operation, data packets are received by the layer2 processing layer 324. After layer2 processing (e.g., extracting next hop information), the flow based packet classification layer 322 classifies the packet or determines that the packet cannot be classified. The layer3 routing layer 320 then routes the data packets to the next hop based on the policy associated with the packet or, if the packet is unclassified, based on another routing technique (e.g., LPM routing). In the routing process, data packets may be forwarded to the layer2 processing layer 324, which adds a layer2 header to the packet (i.e., a layer3 packet is encapsulated in a layer2 header) and forwards the packets to an interface attached to the SW FE 112 (e.g., the CPU ports 116).

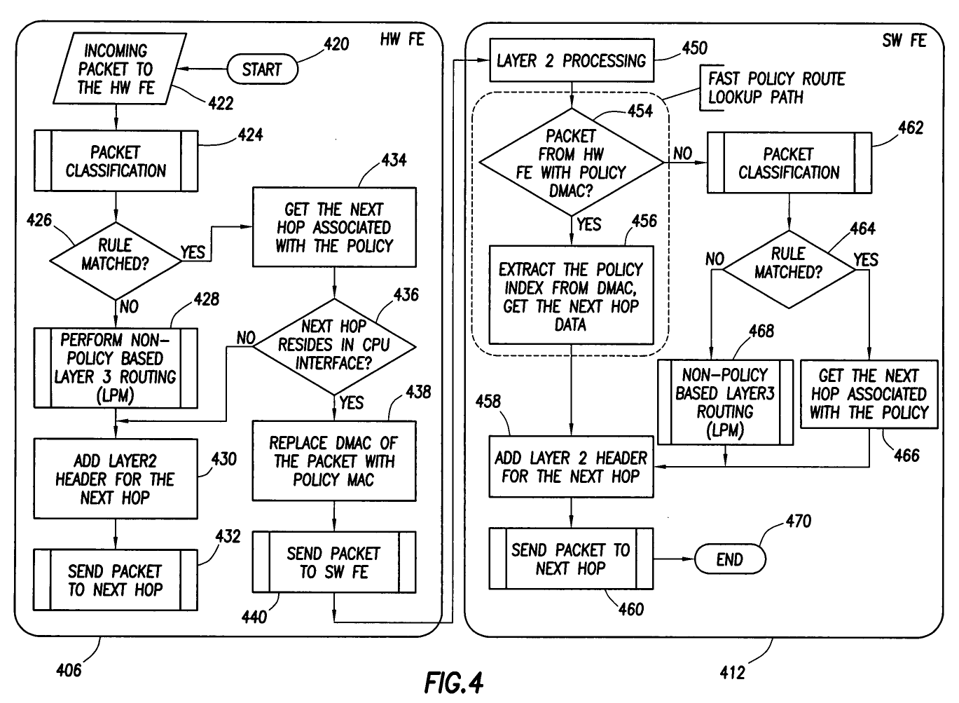

FIG. 4 illustrates flowcharts for hardware forwarding engine (HW FE) and software forwarding engine (SW FE) processes in accordance with embodiments of the invention. As shown in FIG. 4, a process performed by the HW FE 406 starts at block 420. At block 422, an incoming packet is received by the HW FE 406. The packet is classified at block 424. If a policy (or rule) does not match with the packet (determination block 426), the HW FE 406 performs non-policy based layer3 routing (e.g., LPM routing) at block 428. A layer2 header is then added for the next hop (block 430) and the packet is sent to the next hop (block 432).

If a policy (or rule) matches (determination block 426), the HW FE 406 inspects the next hop associated with the policy (block 434). If the next hop does not reside in a CPU interface (determination block 436), a layer2 header is added for the next hop (block 430) and the packet is sent to the next hop (block 432). If the next hop resides in a CPU interface (determination block 436), a DMAC of the packet is modified or replaced with a policy Media Access Control (MAC) that indicates classification results such as policy index information or classification failure (block 438). The HW FE 406 then sends the packet to the SW FE 412 (block 440).

As shown, the SW FE 412 performs layer2 processing of packets received from the HW FE 406 at block 450. If the packet from the HW FE 406 does not have policy information in the DMAC data field (determination block 454), the packet is classified by the SW FE 412 (block 462). In other words, the SW FE 412 performs the entire classification process to determine a policy associated with the packet or to determine that the packet cannot be classified. If a policy does not match with the packet (determination block 464), non-policy based layer3 routing (e.g., LPM routing) is performed (block 468). If a policy matches with the packet (determination block 464), the next hop associated with the policy is obtained (block 460). In either case, a layer2 header is added for the next hop (block 458). The packet is then sent to the next hop (block 460) and the process ends (block 470).

In alternative embodiments, if packets received from the HW FE 406 do not have policy information in the DMAC data field (determination block 454), the SW FE 412 automatically forwards the packets to block 468 for non-policy based layer3 routing. Accordingly, the packet classification performed at block 462 can be, but is not always performed if a packet's DMAC data field does not provide policy information. For example, if the SW FE 412 determines that an attempt was previously and unsuccessfully made to classify the packet (e.g., failure information is provided) and/or if the SW FE 412 determines that a packet is received from an interface configured to provided policy information when a packet is successfully classified (e.g., the HW FE 406), the SW FE 412 can forego the packet classification performed at block 462 and forwards the packet to block 468 for non-policy based layer3 routing (i.e., the SW FE 412 assumes that the packet cannot be classified).

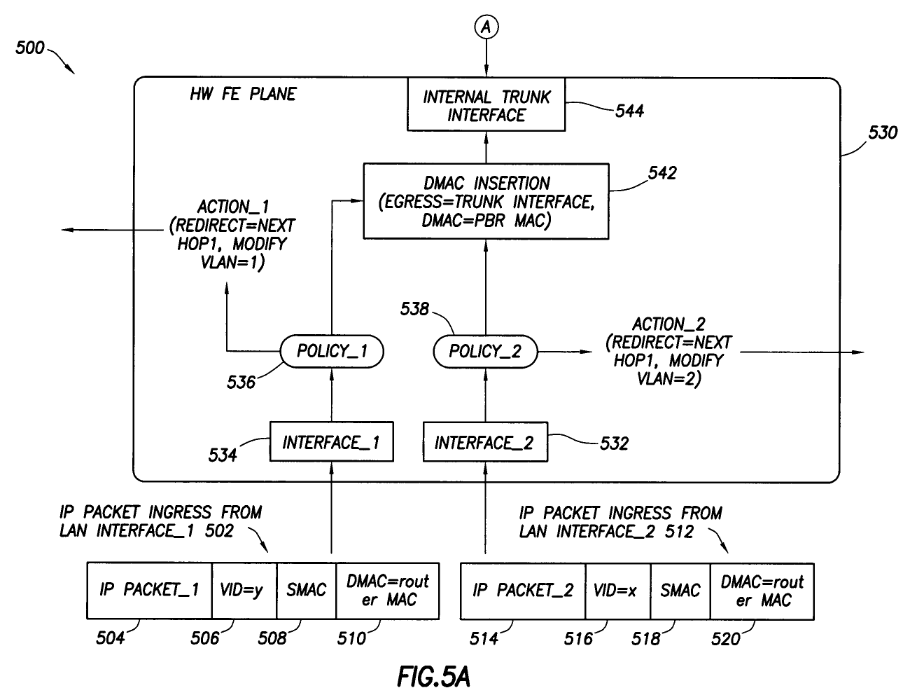

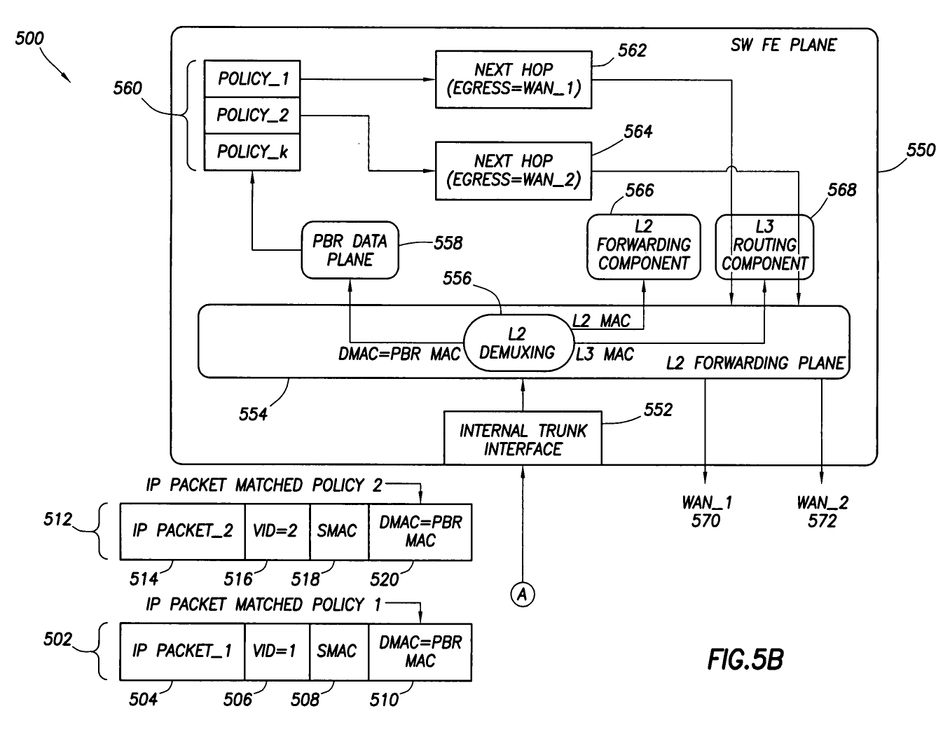

FIGS. 5A-5B illustrate a block diagram of packets traversing a hardware forwarding engine (HW FE) plane 530 and a software forwarding engine (SW FE) plane 550 in accordance with embodiments of the invention. As shown in FIG. 5A, the HW FE 530 receives two packets 502 and 512. The packet 502 comprises a data field 504 that identifies the packet 502. For example, in FIG. 1, the data field 504 identifies the packet 502 as “IP packet_{—}1”. The packet 502 also comprises a data field 506 providing Virtual Local Area Network (VLAN) identification information referred to as “VID” (e.g., VID=y), a data field 508 providing source address (SMAC) information and a data field 510 providing destination address (DMAC) information. Similarly, the packet 512 comprises a data field 514 that identifies the packet 512 as “IP packet_{—}2”. The packet 512 also comprises a data field 516 providing VID information (e.g., VID=x), a data field 518 providing source address (SMAC) information and a data field 520 providing destination address (DMAC) information.

As shown, the packet 502 is received by an interface (“interface_1”) 534 which may be a LAN interface. Similarly, the packet 512 is received by an interface (“interface_2”) 532 which may also be a LAN interface. The packet 502 is classified by a policy component (“policy_1”) 536 and the packet 512 is classified by a policy component (“policy_2) 538. Based on the classification (or classification failure) provided by the policy component 536, an action (“Action_{—}1”) is performed to route the packet 502 to an appropriate interface (other than the SW FE plane 550) using policy based routing or non-policy based layer3 routing. As shown, the Action_{—}1 may involve setting a redirect value (“REDIRECT”) to NEXTHOP1 and setting a modify VLAN value (“MODIFY VLAN”) to 1. Likewise, the policy component 538 may perform an action (“Action_{—}2”) based on the classification (or classification failure) that routes the packet 512 to an appropriate interface. The Action_{—}2 may involve setting a redirect value (“REDIRECT”) to NEXTHOP1 and setting a modify VLAN value (“MODIFY VLAN”) to 2.

If the policy component 536 determines that the packet 502 is intended for the SW FE plane 550, the packet 502 is forwarded to the DMAC insertion component 542 which sets the packet's egress value (“EGRESS”) to an interface (“TRUNK INTERFACE”) corresponding to the SW FE plane 550. If a classification was successfully determined for the packet 502, the DMAC insertion component 542 also sets the packet's DMAC value (“DMAC”) to a predetermined policy based routing (PBR) MAC. Likewise, if the policy component 538 determines that the packet 512 is intended for the SW FE plane 550, the packet 512 is forwarded to the DMAC insertion component 542 which sets the packet's egress value (“EGRESS”) to an interface (“TRUNK INTERFACE”) corresponding to the SW FE plane 550. If a classification was successfully determined for the packet 512, the DMAC insertion component 542 also sets the packet's DMAC value (“DMAC”) to a predetermined policy based routing (PBR) MAC. Packets sent to the SW FE plane 550 are forwarded through HW FE plane's internal trunk interface 544 to the SW FE plane's internal trunk interface 552.

FIG. 5B shows the packets 502 and 512 being forwarded from the HW FE plane 530 to the SW FE plane 550. As shown in FIG. 5B, the packet 502 has been modified by the HW FE plane 530 such that the VID data field 506 indicates VID=1 and the DMAC data field 510 indicates DMAC=PBR MAC (i.e., the packet 502 is to be routed using the fast lookup process previously discussed). Also, the packet 512 has been modified such that the VID data field 516 indicates VID=2 and the DMA data field 520 indicates DMAC=PBR MAC (i.e., the packet 512 is to be routed using the fast lookup process previously discussed). Although FIG. 5B shows the DMAC data fields 510 and 520 as being modified to include policy information (e.g., classification results such as a policy index value or classification failure), there are circumstances when these DMAC data fields 510 and 520 would not include the policy information. For example, if the HW FE plane 530 was unable to classify the packets 502 and 512, the DMAC data fields 510 and 520 may provide the unmodified DMAC information (i.e., the classification failure information is not provided or is provided without modifying the DMAC information).

The packets 502 and 512 are forwarded through the internal trunk interface 552 to SW FE plane's layer2 (“L2”) forwarding plane 554 which has L2 demuxing component 556. The L2 demuxing component 556 forwards the packets 502 and 512 to one of a PBR data plane 558, a L2 forwarding component 566 or a L3 routing component 568 based on information in the DMAC data fields 510 and 520. For example, if the DMAC data field 510 of the packet 502 indicates a PBR MAC (i.e., classification results), the L2 demuxing component 556 forwards the packet 502 to the PBR data plane 558. If the DMAC data field 510 of the packet 502 indicates a L2 MAC, the L2 demuxing component 556 forwards the packet 502 to the L2 forwarding component 566. If the DMAC data field 510 of the packet 502 indicates a L3 MAC, the L2 demuxing component 556 forwards the packet 502 to the L3 routing component 568. The packet 512 would be forwarded in like manner by the L2 demuxing component 556 (based on the contents of the DMAC data field 520).

If the packet 502 is forwarded to the PBR data plane 558, one of a plurality of policies (policy_1 to policy_k) 560 can be looked up directly using the BPR MAC value (without performing the entire search and classification process). The policy determines the next hop for the packet 502. For example, if the packet 502 is determined to be associated with policy_1, the next hop component 562 sets the packet's egress value (“EGRESS”) to WAN_{—}1 and routes the packet 502 to the WAN_{—}1 interface 570 via the L3 routing component 568. Alternatively, if the packet 502 is determined to be associated with policy_2, the next hop component 564 sets the packet's egress value (“EGRESS”) to WAN_{—}2 and routes the packet 502 to the WAN_{—}2 interface 572 via the L3 routing component 568 and so on. If the packet 512 is forwarded to the PBR data plane 558, the same discussion would apply.

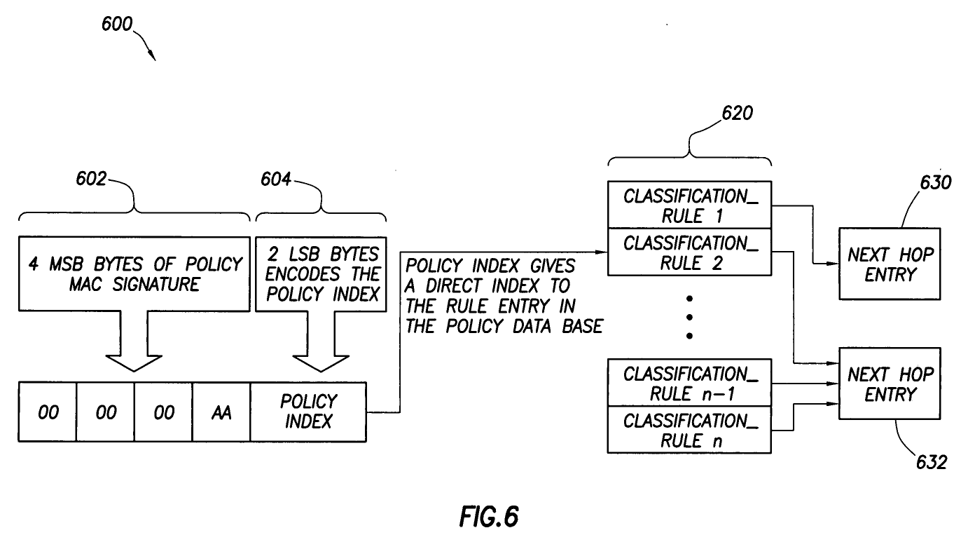

FIG. 6 illustrates a policy encoding scheme 600 in accordance with embodiments of the invention. The policy encoding scheme 600 may be implemented, for example, with the embodiments illustrated in FIGS. 1, 2, 3, 4, and 5A-5B. As shown, the policy encoding scheme 600 comprises encoding a data field with a policy MAC signature 602 and a policy index 604. For example, in some embodiments, a DMAC data field can be modified to include a four-byte policy MAC signature and a two-byte policy index. The policy MAC signature enables a SW FE to recognize when a packet received from a HW FE includes classification results. The policy index 604 gives a direct index to policies (or rules) 620 in a policy database. Each of the policies (“classification_rule 1” to “classification_rule n”) 620 is associated with one of a plurality of next hop entries 630 and 632. For example, the classification_rule 1 may be associated with the next hop entry 630, while classification_rule 2 to classification_rule n are associated with the next hop entry 632.

In at least some embodiments, the policy index 604 is used to give a classification failure value. In such embodiments, PBR data plane 558 shown in FIG. 5 would detect the classification failure value and redirect the packet for routing using non-policy based routing. Alternatively, one of the policies 620 could be associated with the classification failure value. In such case, this policy would provide any information needed to forward the packet for non-policy based routing. In either case, if a HW FE fails to classify a packet, the SW FE does not repeat the entire classification process

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A system, comprising:
a hardware forwarding engine that performs policy based routing; and
a processor coupled to communicate with the hardware forwarding engine, the processor having a software forwarding engine that performs policy based routing,
wherein, if data packets are forwarded from the hardware forwarding engine to the software forwarding engine, the hardware forwarding engine modifies a header of at least some of the data packets to include policy information.

2. The system of claim 1 wherein the policy information comprises a signature that enables the software forwarding engine to recognize when the header has been modified to include policy information.

3. The system of claim 1 wherein the policy information comprises a policy index value that enables the software forwarding engine to directly look up a policy from a policy database.

4. The system of claim 1 wherein the policy information comprises failure information that indicates the hardware forwarding engine was unable to determine a policy for the data packet.

5. The system of claim 4 wherein, if the software forwarding engine receives the failure information, the software forwarding engine automatically routes the data packet based on non-policy based routing.

6. The system of claim 1 wherein the hardware forwarding engine comprises a packet classification component that classifies packets based on Ternary Content Addressable Memory (TCAM).

7. The system of claim 1 wherein the data packet comprises a layer3 packet and the header comprises a layer2 header.

8. The system of claim 7 wherein the processor comprises a layer2 forwarding plane that extracts the policy information from the layer2 header and, based on the policy information, causes the data packet to be forwarded to one of a policy based routing data plane, a layer2 forwarding component, and a layer3 routing component.

9. The system of claim 1 wherein a destination media access control (DMAC) data field of the header is modified to include the policy information.

10. A method, comprising:
determining a policy associated with a data packet, said determining being performed by a hardware forwarding engine; and
if a next hop of the data packet is a processor interface, selectively modifying a header of the data packet to include policy information that can be used by a processor associated with the processor interface to identify the policy.

11. The method of claim 10 wherein modifying the header comprises inserting a signature into a data field of the header, the signature indicating the header has been modified to include the policy information.

12. The method of claim 10 wherein modifying the header comprises inserting a policy index value into a data field of the header, the policy index value enabling the processor to directly look up a policy from a policy database.

13. The method of claim 10 wherein modifying the header comprises inserting failure information into a data field of the header, the failure information indicating that the hardware forwarding engine failed to associate a policy with the data packet.

14. The method of claim 13 further comprising extracting, by the processor, the failure information in the header and automatically routing the data packet using non-policy based routing.

15. The method of claim 10 further comprising, if the hardware forwarding interface does not determine a policy associated with the data packet, routing the data packet using longest prefix match (LPM) routing.

16. A routing system, comprising:
a hardware forwarding engine that classifies data packets received from a network interface; and
a processor coupled to communicate with the hardware forwarding engine, the processor having a software forwarding engine that classifies data packets received from a processor interface,
wherein, if a data packet received from the network interface is destined for the processor interface, the hardware forwarding engine classifies the data packet, inserts classification results into a header of the data packet, and forwards the data packet to the processor,
wherein the software forwarding engine is configured to extract the classification results from the header of the data packet received from the hardware forwarding engine and to route the data packet based on the classification results.

17. The routing system of claim 16 wherein the classification results are inserted into a destination media access control (DMAC) data field of the header.

18. The routing system of claim 16 wherein the classification results comprise a policy index value that corresponds to classification policies stored in a database, the database being accessible to the software forwarding engine.

19. The routing system of claim 16 wherein the classification results comprise a classification failure.

20. The routing system of claim 16 wherein the hardware forwarding engine only inserts classification results into a data packet's header if the data packet is destined for the processor interface.
